(19) United States
(12) Patent Application Publication
(10) Pub. No.: US 2026/0037548 A1
(43) Pub. Date: Feb. 5, 2026

(54) SYSTEMS AND METHODS FOR DETERMINING AND UPDATING KNOWLEDGE GRAPHS OF INFORMATION TECHNOLOGY EVENT DATA AND CONFIGURATION ITEMS

(71) Applicant: Fidelity Information Services, LLC, Jacksonville, FL (US)

(72) Inventors: Ranadhir GHOSH, St. Johns, FL (US); John PLATAIS, Menomonee Falls, WI (US); Shavone S. JOSEPH, Philadelphia, PA (US)

(21) Appl. No.: 18/791,262

(22) Filed: Jul. 31, 2024

(51) Int. Cl. G06F 16/28

(52) U.S. Cl. CPC G06F 16/288

(57) ABSTRACT

A computer-implemented method for managing information technology event data in a graph database, the method including: obtaining a graph database, the graph database including a set of nodes and set of edges that connect the set of nodes; receiving a first data, the first data object, the first data object and second data object representing information technology data; processing the first data object, wherein processing the first data object includes assigning a first identification field to the first data object and identifying additional fields of the first data object; determining the first data object does not exist as a node in the graph database; creating a first node for the first data object and assigning the first identification field to the first node; creating a first edge connecting the first data object to a first related node from the set of nodes of the graph database.

### TECHNICAL FIELD

Various embodiments of the present disclosure relate generally to information technology (IT) management systems and, more particularly, to systems and methods for determining and updating knowledge graphs of IT event data and configuration items.

### BACKGROUND

In computing systems, for example computing systems that perform financial services and electronic payment transactions, programing changes may occur. For example, software may be updated. Changes in the system may lead to defects, issues, bugs or problems (collectively referred to as incidents) within the system. These incidents may occur at the time of a software change or at a later time. These incidents may be costly for the company as users may not be able to use the services and due to resources expended by the company to resolve the incidents.

These incidents in the system may need to be examined and resolved in order to have the software services perform correctly. Time may be spent by, for example, incident resolution teams, determining what issues arose within the software services. The faster an incident may be resolved, the less potential costs a company may incur. Thus, promptly identifying and fixing such incidents (e.g., writing new code or updating deployed code) may be important to a company.

Managing, analyzing, and deriving insights form diverse data types from various origins may be complicated. Further comprehending the connections and extracting meaningful patterns from received data may be challenging. The present disclosure is directed to addressing this and other drawbacks to the existing computing system incident analysis techniques.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

In some aspect, the techniques described herein relate to a computer-implemented method for managing information technology event data in a graph database, the method including: obtaining a graph database, the graph database including a set of nodes and set of edges that connect the set of nodes; receiving a first data object and a second data object from a data source, the first data object, the first data object and second data object representing information technology data; processing the first data object and the second data object, wherein processing the first data object includes assigning a first identification field to the first data object and identifying additional fields of the first data object, wherein processing the second data object includes assisting a second identification filed to the second data object and identifying additional fields of the second data object; determining the first data object does not exist as a node in the graph database; creating a first node for the first data object and assigning the first identification field to the first node; creating a first edge connecting the first data object to a first related node from the set of nodes of the graph database; determining the second data object does exist as a second node in the graph database; and updating the second node to include the additional fields of the second data object.

In some aspects, the techniques described herein relate to a computer-implemented method, wherein determining the first data object does not exist as a node in the graph database, further includes: performing a search function to traverse all possible edges of the graph database to determine if the first identification field of the first data object exists as an identification field for any of the set of nodes in the graph database.

In some aspects, the techniques described herein relate to a computer-implemented method, wherein creating a first node for the first data object further includes: creating a third edge connection to a first time node, the first time node identifying a time that the first data object occurred, the time being identified from a first time stamp associated with the first data object; wherein, wherein the first edge connection is attributed the additional fields of the first data object and indicates an association between the first node and additional data in the graph database.

In some aspects, the techniques described herein relate to a computer-implemented method, wherein the graph database includes attributes for the set of nodes and attributes for the set of edges, wherein the attributes provide additional data related to define the set of nodes and the set of edges.

In some aspects, the techniques described herein relate to a computer-implemented method, wherein each of the first data object and second data object comprises item data, configuration item relationship data, incidents data, alert data, changes data, or problem data.

In some aspects, the techniques described herein relate to a computer-implemented method, further including: determining the first data object is a configuration item object; wherein the additional fields of the first data object include a name, asset class, and active status; wherein creating the first node for the first data object includes: assigning a first label of the first identification field; and assigning a second label of the additional fields to the first data object; wherein creating a first edge connecting the first data object to a first related node from the set of nodes of the graph database includes: identifying a parent relationship and a child relationship; identifying the first related node based upon parent relationship; identifying a second related node based upon the child relationship; and creating a second edge between the first node and second related node extracted from the child relationship.

In some aspects, the techniques described herein relate to a computer-implemented method, further including: determining the first data object is a configuration relationship object, wherein the configuration relationship object defines a relationship between a first configuration item and a second configuration item; wherein the additional fields of the first data object include a first configuration item name identification field, a second configuration item name identification field, an association identification variable, a confidence of association, and an updated date that the association occurred; wherein creating the first node for the first data object, includes: assigning a first label of the first identification field; and assigning a second label of the additional fields to the first data object; wherein creating a first edge connecting the first data object to a first related node from the set of nodes of the graph database includes: wherein the first related node is associated with the first configuration item name identification field; and identifying a second related node associated with the second configuration item name identification field; creating a second edge between the first node and the second related node; and creating a third edge between the first node and a date node associated with the updated date from the additional fields of the first data object.

In some aspects, the techniques described herein relate to a computer-implemented method, further including: determining the first data object is an event object; wherein creating the first node for the first data object, includes: assigning a first label of the first identification field; and assigning a second label of the additional fields to the first data object; wherein the first related data object is identified based on the additional fields of the first data object.

In some aspects, the techniques described herein relate to a computer-implemented method, wherein the graph database includes a time tree node structure, the time tree node structure including: a year node; twelve month nodes; edges between the year node and each of the twelve month nodes; nodes for each day of each of the twelve month nodes; and edges between each day and the respective month nodes; wherein, creating a second edge, linking the first node to a temporal node, wherein the temporal node represents a day that the first data object occurred or was opened on.

In some aspects, the techniques described herein relate to a system for managing information technology event data in a graph database, the system including: a memory having processor-readable instructions stored therein; and at least one processor configured to access the memory and execute the processor-readable instructions to perform operations including: obtaining a graph database, the graph database including a set of nodes and set of edges that connect the set of nodes; receiving a first data object and a second data object from a data source, the first data object, the first data object and second data object representing information technology data; processing the first data object and the second data object, wherein processing the first data object includes assigning a first identification field to the first data object and identifying additional fields of the first data object, wherein processing the second data object includes assisting a second identification filed to the second data object and identifying additional fields of the second data object; determining the first data object does not exist as a node in the graph database; creating a first node for the first data object and assigning the first identification field to the first node; creating a first edge connecting the first data object to a first related node from the set of nodes of the graph database; determining the second data object does exist as a second node in the graph database; and updating the second node to include the additional fields of the second data object.

In some aspects, the techniques described herein relate to a system, wherein determining the first data object does not exist as a node in the graph database, further includes: performing a search function to traverse all possible edges of the graph database to determine if the first identification field of the first data object exists as an identification field for any of the set of nodes in the graph database.

In some aspects, the techniques described herein relate to a system, wherein creating a first node for the first data object further includes: creating a third edge connection to a first time node, the first time node identifying a time that the first data object occurred, the time being identified from a first time stamp associated with the first data object; wherein, wherein the first edge connection is attributed the additional fields of the first data object and indicates an association between the first node and additional data in the graph database.

In some aspects, the techniques described herein relate to a system, wherein the graph database includes attributes for the set of nodes and attributes for the set of edges, wherein the attributes provide additional data related to define the set of nodes and the set of edges.

In some aspects, the techniques described herein relate to a system, wherein each of the first data object and second data object comprises item data, configuration item relationship data, incidents data, alert data, changes data, or problem data.

In some aspects, the techniques described herein relate to a system, further including: determining the first data object is a configuration item object; wherein the additional fields of the first data object include a name, asset class, and active status; wherein creating the first node for the first data object includes: assigning a first label of the first identification field; and assigning a second label of the additional fields to the first data object; wherein creating a first edge connecting the first data object to a first related node from the set of nodes of the graph database includes: identifying a parent relationship and a child relationship; identifying the first related node based upon parent relationship; identifying a second related node based upon the child relationship; and creating a second edge between the first node and second related node extracted from the child relationship.

In some aspects, the techniques described herein relate to a system, further including: determining the first data object is a configuration relationship object, wherein the configuration relationship object defines a relationship between a first configuration item and a second configuration item; wherein the additional fields of the first data object include a first configuration item name identification field, a second configuration item name identification field, an association identification variable, a confidence of association, and an updated date that the association occurred; wherein creating the first node for the first data object, includes: assigning a first label of the first identification field; and assigning a second label of the additional fields to the first data object; wherein creating a first edge connecting the first data object to a first related node from the set of nodes of the graph database includes: wherein the first related node is associated with the first configuration item name identification field; and identifying a second related node associated with the second configuration item name identification field; creating a second edge between the first node and the second related node; and creating a third edge between the first node and a date node associated with the updated date from the additional fields of the first data object.

In some aspects, the techniques described herein relate to a system, further including: determining the first data object is an event object; wherein creating the first node for the first data object, includes: assigning a first label of the first identification field; and assigning a second label of the additional fields to the first data object; wherein the first related data object is identified based on the additional fields of the first data object.

In some aspects, the techniques described herein relate to a system, wherein the graph database includes a time tree node structure, the time tree node structure including: a year node; twelve month nodes; edges between the year node and each of the twelve month nodes; nodes for each day of each of the twelve month nodes; and edges between each day and the respective month nodes; wherein, creating a second edge, linking the first node to a temporal node, wherein the temporal node represents a day that the first data object occurred or was opened on.

In some aspects, the techniques described herein relate to a non-transitory computer readable medium storing processor-readable instructions which, when executed by at least one processor, cause the at least one processor to perform operations including: obtaining a graph database, the graph database including a set of nodes and set of edges that connect the set of nodes; receiving a first data object and a second data object from a data source, the first data object, the first data object and second data object representing information technology data; processing the first data object and the second data object, wherein processing the first data object includes assigning a first identification field to the first data object and identifying additional fields of the first data object, wherein processing the second data object includes assisting a second identification filed to the second data object and identifying additional fields of the second data object; determining the first data object does not exist as a node in the graph database; creating a first node for the first data object and assigning the first identification field to the first node; creating a first edge connecting the first data object to a first related node from the set of nodes of the graph database; determining the second data object does exist as a second node in the graph database; and updating the second node to include the additional fields of the second data object.

In some aspects, the techniques described herein relate to a non-transitory computer readable medium, wherein determining the first data object does not exist as a node in the graph database, further includes: performing a search function to traverse all possible edges of the graph database to determine if the first identification field of the first data object exists as an identification field for any of the set of nodes in the graph database.

### BRIEF DESCRIPTION OF THE DRAWINGS

The accompanying drawings, which are incorporated in and constitute a part of this specification, illustrate several embodiments and together with the description, serve to explain the principles of the disclosure.

FIG. 1 depicts an exemplary system overview for a data pipeline for an artificial intelligence model to predict and troubleshoot incidents in a system, according to one or more embodiments.

FIG. 2 depicts a flowchart for managing configuration items and time-based correlated events in a graph database, according to one or more embodiments.

FIG. 3A depicts a flowchart for creating relationships in a graph database, according to one or more embodiments.

FIG. 3B depicts a flowchart of a method for managing information technology event data in a graph database, according to one or more embodiments

FIG. 4 depicts an exemplary diagram of a graph database structure for event nodes and a configuration item node, according to one or more embodiments.

FIG. 5 depicts an exemplary node diagram for configuration item association nodes, according to one or more embodiments.

FIG. 6 depicts an exemplary hierarchical graph of associated configuration item, according to one or more embodiments.

FIG. 7 depicts a flowchart for processing and storing association rules in a graph database, according to one or more embodiments.

FIG. 8 depicts an exemplary segment of a graph database's hierarchy, according to one or more embodiments.

FIG. 9 depicts an exemplary graph of a Line of Business (LOB) and associated nodes, according to one or more embodiments.

FIG. 10 depicts an exemplary graph of incidents that occurred during a day time interval, according to one or more embodiments.

FIG. 11 depicts an exemplary graph of correlated configuration items, according to one or more embodiments.

FIG. 12 illustrates a computer system for executing the techniques described herein, according to one or more embodiments of the present disclosure.

### DETAILED DESCRIPTION OF EMBODIMENTS

Various embodiments of the present disclosure relate generally to information technology (IT) management systems and, more particularly, to systems and methods for determining knowledge graph and extracting of data for heterogeneous and asynchronous IT operations event data

The subject matter of the present disclosure will now be described more fully with reference to the accompanying drawings that show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Software companies have been struggling to avoid outages from incidents that may be caused by upgrading software or hardware components, or changing a member of a team, for example. The system described herein may be configured to analyze and/or process event data for an IT system. The system described herein may for example receive a stream of event data over periods of time. Event data may include, but is not limited: (1) an incident, (2) an alert, (3) change data, (4) a problem; and/or an anomaly.

An incident may be an occurrence that can disrupt or cause a loss of operation, services, or functions of a system. Incidents may be manually reported by customers or personnel, may be automatically logged by internal systems, or may be captured in other ways. An incident may occur from factors such as hardware failure, software failure, software bugs, human error, and/or cyber attacks. Deploying, refactoring, or releasing software code may for example cause an incident. An incident may be detected during, for example, an outage or a performance change. An incident may include characteristics, where an incident characteristic may refer to the quality or traits associated with an incident. For example, incident characteristics may include, but is not limited to, the severity of an incident, the urgency of an incident, the complexity of an incident, the scope of an incident, the cause of an incident, and/or what configurable item corresponds to the incident (e.g., what systems/platforms/products etc. are affected by the incident), how it is described in freeform text, what business segment is effected, what category/subcategory is affected, and/or what assigned group is the incident.

An alert may refer to a notification that informs a system or user of an event. An alert may include a collection of events representing a deviation from normal behavior for a system. For example, an alert may include metadata including a short field description that includes free from text fields (e.g., a summary of the alert), first occurrences, time stamps, an alert key, etc. Understanding the different types of alerts within a system from various perspectives may assist in resolving incidents.

Change data may refer to information that described a modification made to data within a system or database. Change data may track the changes that occur over one or more periods of time. Problem data may refer to any data that causes issues or impedes a systems normal operations. Anomaly data may refer to data that indicates a deviation of a system from a standard or normal operation.

The event data may further include entities effected by the event and their respective relationships. Event data may be associated with one or more configurable items (CIs). A configurable item (CI) may refer a component of a system that can be identified as a self-contained unit for purposes of change control and identification. For example, a particular application, service, particular product, server, may be defined by a CI.

Conventional data pipeline systems may face challenges in effectively managing, analyzing, and deriving insights from diverse data types from various origins. These data types include events, entities, and their intricate relationships, making it difficult to comprehend connections, extract meaningful patterns, and make informed decisions. Conventional systems often struggle to integrate and process these diverse data types, hindering comprehensive analytics, scalability, and adaptability to evolving business environments.

Further, it may be challenging to efficiently manage and update a database that stores IT related information. Graphing the dependencies and interactions between or among different CIs may be crucial for predicting potential impact of events, such as incidents or changes. Issues in graphing dependencies can increase the risk of extended downtime, system instability, and reduced operational efficiency. The system described herein may effectively map the relationships between CIs, allowing for the system to discover correlation among CIs that may not be accounted for within an existing CI hierarchy or direct correlation between CIs that are affected by incidents in the same period.

The system described herein may incorporate knowledge based graphs to address the issues of conventional systems. Knowledge based graphs may represent complex relationships and interconnected data in a way that reflects real world scenarios. Knowledge based graphs may enable a more intuitive representation of information, facilitating more accurate and efficient data analysis, retrieval, and reasoning. The knowledge based graphs may offer a structured and interconnected view of knowledge which can be queried and explored efficiently for fields like artificial intelligence (AI), natural language process (NLP), recommendation systems, etc. Graph databases, such as Neo4j, may provide a robust foundation for managing event data and represent intricate relationships as nodes and edges for more intuitive modeling. The graph databases may also provide a flexible framework for modelling the temporal aspects of the event data using timestamps associated with event data.

The system described herein may identify connections between unrelated configuration items, including orphaned CIs with insufficient hierarchy information. An orphaned CI may refer to a CI in a graph database that is not linked (e.g., by an edge) to a separate CI node. Unidentified correlations between configuration items may presents a challenge to predictive insights during ongoing incidents. Conventional systems lack the ability to understand dynamic relationships within complex hierarchies. The system described herein may leverage association rules generated from historical and current data, to discover correlation between unrelated CIs, and then store these relationships within a graph database, allowing for efficient querying and visualization. The system may implement real-time updates to create a dynamic graph and efficiently update and/or created new relationships when new data is received. The determined graph may allow for efficient filtering and for algorithms to be applied to identify potentially problematic CIs, enhancing proactive incident identification and response.

One or more embodiments may allow for various types of data processing in order to identify correlations, similarity, and root causes, and recommend a corrective action based on received data as well as user feedback mechanisms. One or more embodiments may be extended to clients and users of services and software with applications that are connected to the system described herein.

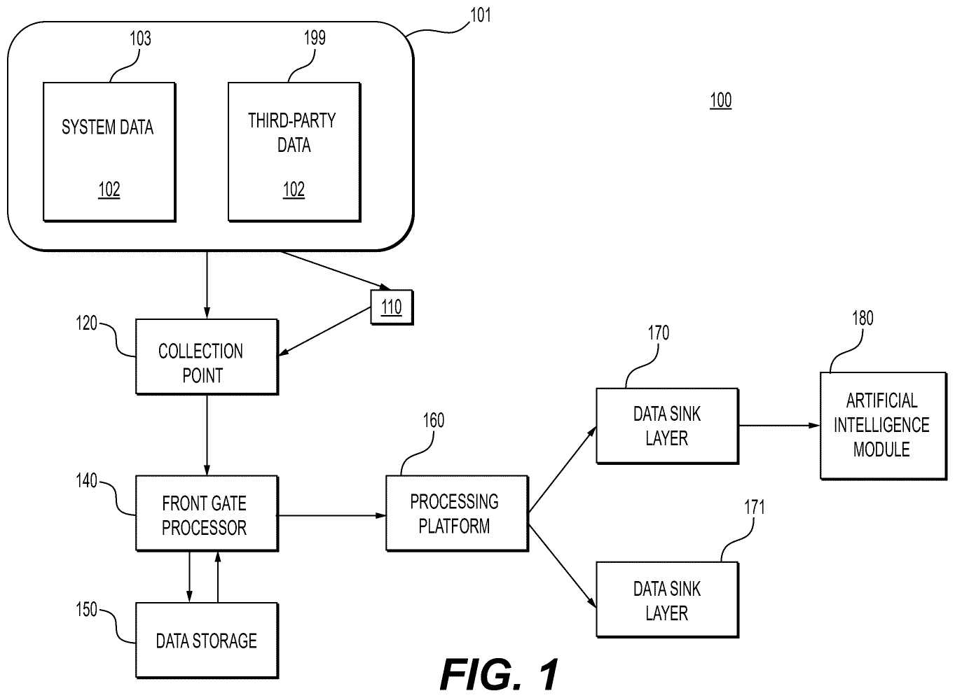

FIG. 1 depicts an exemplary system overview for a data pipeline for an artificial intelligence model to analyze IT data in a system, according to one or more embodiments. For example, the data pipeline system 100, may aggregate and send IT data to a sink layer 170. The data pipeline system 100 may be a platform with multiple interconnected components. The data pipeline system 100 may include one or more servers, intelligent networking devices, computing devices, components, and corresponding software for aggregating and processing data.

As shown in FIG. 1, a data pipeline system 100 may include a data source 101, a collection point 120, a secondary collection point 110, a front gate processor 140, data storage 150, a processing platform 160, a data sink layer 170, a data sink layer 171, and an artificial intelligence module 180.

The data source 101 may include in-house data 103 and third party data 199. The in-house data 103 may be a data source directly linked to the data pipeline system 100. Third party data 199 may be a data source connected to the data pipeline system 100 externally as will be described in greater detail below.

Both the in-house data 103 and third party data 199 of the data source 101 may include incident data 102. Incident data 102 may include incident reports with information for each incident provided with one or more of an incident number, closed date/time, category, close code, close note, long description, short description, root cause, or assignment group. Incident data 102 may include incident reports with information for each incident provided with one or more of an issue key, description, summary, label, issue type, fix version, environment, author, or comments. Incident data 102 may include incident reports with information for each incident provided with one or more of a file name, script name, script type, script description, display identifier, message, committer type, committer link, properties, file changes, or branch information. Incident data 102 may include one or more of real-time data, market data, performance data, historical data, utilization data, infrastructure data, or security data. These are merely examples of information that may be used as data, and the disclosure is not limited to these examples.

Incident data 102 may be generated automatically by monitoring tools that generate alerts and incident data to provide notification of high-risk actions, failures in IT environment, and may be generated as tickets. Incident data may include metadata, such as, for example, text fields, identifying codes, and time stamps.

The in-house data 103 may be stored in a relational database including an incident table. The incident table may be provided as one or more tables, and may include, for example, one or more of problems, tasks, risk conditions, incidents, or changes. The relational database may be stored in a cloud. The relational database may be connected through encryption to a gateway. The relational database may send and receive periodic updates to and from the cloud. The cloud may be a remote cloud service, a local service, or any combination thereof. The cloud may include a gateway connected to a processing API configured to transfer data to the collection point 120 or a secondary collection point 110. The incident table may include incident data 102.

The data pipeline system 100 may include third party data 199 generated and maintained by third party data producers. Third party data producers may produce incident data 102 from Internet of Things (IoT) devices, desktop-level devices, and sensors. Third party data producers may include but are not limited to Tryambak, Appneta, Oracle, Prognosis, ThousandEyes, Zabbix, ServiceNow, Density, Dyatrace, etc. The incident data 102 may include metadata indicating that the data belongs to a particular client or associated system.

The data pipeline system 100 may include a secondary collection point 110 to collect and pre-process the incident data 102 from the data source 101. The secondary collection point 110 may be utilized prior to transferring data to a collection point 120. The secondary collection point 110 point may for example be an Apache Minifi software. In one example, the secondary collection point 110 may run on a microprocessor for a third party data producer. Each third party data producer may have an instance of the secondary collection point 110 running on a microprocessor. The secondary collection point 110 may support data formats including but not limited to JSON, CSV, Avro, ORC, HTML, XML, and Parquet. The secondary collection point 110 may encrypt incident data 102 collected from the third party data producers. The secondary collection point 110 may encrypt incident data, including, but not limited to, Mutual Authentication Transport Layer Security (mTLS), HTTPs, SSH, PGP, IPsec, and SSL. The secondary collection point 110 may perform initial transformation or processing of incident data 102. The secondary collection point 110 may be configured to collect data from a variety of protocols, have data provenance generated immediately, apply transformations and encryptions on the data, and prioritize data.

The data pipeline system 100 may include the collection point 120. The collection point 120 may be a system configured to provide a secure framework for routing, transforming, and delivering data across from the data source 101 to downstream processing devices (e.g., a front gate processor 140). The collection point 120 may for example be a software such as Apache NiFi. The collection point 120 may receive raw data and the data's corresponding fields such as the source name and ingestion time. The collection point 120 may run on a Linux Virtual Machine (VM) on a remote server. The collection point 120 may include one or more nodes. For example, the collection point 120 may receive incident data 102 directly from the data source 101. In another example, the collection point 120 may receive the incident data 102 from the secondary collection point 110. The secondary collection point 110 may transfer the incident data 102 to the collection point 120 using, for example, Site-to-Site protocol. The collection point 120 may include a flow algorithm. The flow algorithm may connect different processors, as described herein, to transfer and modify data from one source to another. For each third party data producer, the collection point 120 may have a separate flow algorithm. Each flow algorithm may include a processing group. The processing group may include one or more processors. The one or more processors may, for example, fetch the incident data 102 from the relational database. The one or more processors may utilize the processing API of the in-house data 103 to make an API call to a relational database to fetch incident data 102 from the incident table. The one or more processors may further transfer the incident data 102 to a destination system such as a front gate processor 140. The collection point 120 may encrypt data through HTTPS, Mutual Authentication Transport Layer Security (mTLS), SSH, PGP, IPsec, and/or SSL, etc. The collection point 120 may support data formats including but not limited to JSON, CSV, Avro, ORC, HTML, XML, and Parquet. The collection point 120 may be configured to write messages to clusters of a front gate processor 140 and communication with the front gate processor 140.

The data pipeline system 100 may include a distributed event streaming platform such as the front gate processor 140. The front gate processor 140 may be connected to and configured to receive data from the collection point 120. The front gate processor 140 may be implemented in an Apache Kafka cluster software system. The front gate processor 140 may include one or more message brokers and corresponding nodes. The message broker may for example be an intermediary computer program module that translates a message from the formal messaging protocol of the sender to the formal messaging protocol of the receiver. The message broker may be on a single node in the front gate processor 140. A message broker of the front gate processor 140 may run on a virtual machine (VM) on a remote server. The collection point 120 may send the incident data 102 to one or more of the message brokers of the front gate processor 140. Each message broker may include a topic to store similar categories of incident data 102. A topic may be an ordered log of events. Each topic may include one or more sub-topics. For example, one sub-topic may store the incident data 102 relating to network problems, and another sub-topic may store the incident data 102 related to security breaches from third party data producers. Each topic may further include one or more partitions. The partitions may be a systematic way of breaking the one topic log file into many logs, each of which can be hosted on a separate server. Each partition may be configured to store as much as a byte of the incident data 102. Each topic may be partitioned evenly between one or more message brokers to achieve load balancing and scalability. The front gate processor 140 may be configured to categorize the received data into a plurality of client categories, thereby forming a plurality of datasets associated with the respective client categories. These datasets may be stored separately within the storage device as described in greater detail below. The front gate processor 140 may further transfer data to storage and to processors for further processing.

For example, the front gate processor 140 may be configured to assign particular data to a corresponding topic. Alert sources may be assigned to an alert topic, and the incident data 102 may be assigned to an incident topic. Change data may be assigned to a change topic. Problem data may be assigned to a problem topic.

The data pipeline system 100 may include a software framework for data storage 150. The data storage 150 may be configured for long term storage and distributed processing. The data storage 150 may be implemented using, for example, Apache Hadoop. The data storage 150 may store the incident data 102 transferred from the front gate processor 140. In particular, the data storage 150 may be utilized for distributed processing of the incident data 102, and Hadoop distributed file system (HDFS) within the data storage may be used for organizing communications and storage of the incident data 102. For example, the HDFS may replicate any node from the front gate processor 140. This replication may protect against hardware or software failures of the front gate processor 140. The processing may be performed in parallel on multiple servers simultaneously.

The data storage 150 may include an HDFS that is configured to receive the metadata (e.g., incident data). The data storage 150 may further apply an algorithm to process the data. This processing may allow for parallel processing of large data sets. This algorithm may be implemented by a MapReduce algorithm, for example. The data storage 150 may further aggregate and store the data. Algorithms within data storage 150 may be used for cluster resource management and planning tasks of the stored data. The algorithm may, for example, be Yet Another Resource Negotiation (YARN). For example, a cluster computing framework, such as the processing platform 160, may be arranged to further utilize the HDFS of the data storage 150. For example, if the data source 101 stops providing data, the processing platform 160 may be configured to retrieve data from the data storage 150 either directly or through the front gate processor 140. The data storage 150 may allow for the distributed processing of large data sets across clusters of computers using programming models. The data storage 150 may include a master node and an HDFS for distributing processing across a plurality of data nodes. The master node may store metadata such as the number of blocks and their locations. The main node may maintain the file system namespace and regulate client access to said files. The main node may comprise files and directories and perform file system executions such as naming, closing, and opening files. The data storage 150 may scale up from a single server to thousands of machines, each offering local computation and storage. The data storage 150 may be configured to store the incident data 102 in an unstructured, semi-structured, or structured form. In one example, the plurality of datasets associated with the respective client categories may be stored separately. The master node may store the metadata such as the separate dataset locations.

The data pipeline system 100 may include a real-time processing framework, e.g., a processing platform 160. In one example, the processing platform 160 may be a distributed dataflow engine that does not have its own storage layer. For example, this may be the software platform Apache Flink. In another example, the software platform Apache Spark may be utilized. The processing platform 160 may support stream processing and batch processing. Stream processing may be a type of data processing that performs continuous, real-time analysis of received data. Batch processing may involve receiving discrete data sets processed in batches. The processing platform 160 may include one or more nodes. The processing platform 160 may aggregate incident data 102 (e.g., incident data 102 that has been processed by the front gate processor 140) received from the front gate processor 140. The processing platform 160 may include one or more operators to transform and process the received data. For example, a single operator may filter the incident data 102 and then connect to another operator to perform further data transformation. The processing platform 160 may process incident data 102 in parallel. A single operator may be on a single node within the processing platform 160. The processing platform 160 may be configured to filter and only send particular processed data to a particular data sink layer. For example, depending on the data source of the incident data 102 (e.g., whether the data is in-house data 103 or third party data 199), the data may be transferred to a separate data sink layer (e.g., the data sink layer 170, or the data sink layer 171). Further, additional data that is not required at downstream modules (e.g., at the artificial intelligence module 180) may be filtered and excluded prior to transferring the data to a data sink layer.

The processing platform 160 may perform three functions. First, the processing platform 160 may perform data validation. The data's value, structure, and/or format may be matched with the schema of the destination (e.g., the data sink layer 170). Second, the processing platform 160 may perform a data transformation. For example, a source field, target field, function, and parameter from the data may be extracted. Based upon the extracted function of the data, a particular transformation may be applied. The transformation may reformat the data for a particular use downstream. A user may be able to select a particular format for downstream use. Third, the processing platform 160 may perform data routing. For example, the processing platform 160 may select the shortest and/or most reliable path to send data to a respective sink layer (e.g., the data sink layer 170 and/or the data sink layer 171).

In one example, the processing platform 160 may be configured to transfer particular sets of data to a data sink layer (e.g., the data sink layer 170 and/or the data sink layer 171). For example, the processing platform 160 may receive input variables for a particular artificial intelligence module 180. The processing platform 160 may then filter the data received from the front gate processor 140 and only transfer data related to the input variables of the artificial intelligence module 180 to a data sink layer (e.g., the data sink layer 170 and/or the data sink layer 171).

The data pipeline system 100 may include the one or more data sink layers (e.g., data sink layer 170 and data sink layer 171). Incident data 102 processed from processing platform 160 may be transmitted to and stored in the data sink layer 170. In one example, the data sink layer 171 may be stored externally on a particular client's server. The data sink layer 170 and data sink layer 171 may be implemented using a software such as, but not limited to, PostgreSQL, HIVE, Kafka, OpenSearch, and Neo4j. The data sink layer 170 may receive in-house data 103, which have been processed and received from the processing platform 160. The data sink layer 171 may receive third party data 199, which have been processed and received from the processing platform 160. The data sink layers may be configured to transfer incident data 102 to an artificial intelligence module 180. The data sink layers (e.g., the data sink layer 170 and/or the data sink layer 171) may be data lakes, data warehouses, or cloud storage systems. Each data sink layer (e.g., the data sink layer 170 and/or the data sink layer 171) may be configured to store incident data 102 in both a structured or unstructured format. The data sink layer 170 may store incident data 102 with several different formats. For example, the data sink layer 170 may support data formats such as JavaScript Objection Notation (JSON), comma-separated value (CSV), Avro, Optimized Row Columnar (ORC), Hypertext Markup Language (HTML), Extensible Markup Language (XML), or Parquet, etc. The data sink layer (e.g., data sink layer 170 or data sink layer 171), may be accessed by one or more separate components. For example, the data sink layer may be accessed by a Non-structured Query language (“NoSQL”) database management system (e.g., a Cassandra cluster), a graph database management system (e.g., Neo4j cluster), further processing programs (e.g., Kafka+Flink programs), and a relation database management system (e.g., postgres cluster). Further processing may thus be performed prior to the processed data being received by the artificial intelligence module 180.

The data pipeline system 100 may include the artificial intelligence module 180. The artificial intelligence module 180 may include a machine-learning component. The artificial intelligence module 180 may use the received data in order to train and/or use a machine learning model. The artificial intelligence module 180 may be, for example, a neural network. Nonetheless, it should be noted that other machine learning techniques and frameworks may be used by the artificial intelligence module 180 to perform the methods contemplated by the present disclosure. For example, the systems and methods may be realized using other types of supervised and unsupervised machine learning techniques such as regression problems, random forest, cluster algorithms, principal component analysis (PCA), reinforcement learning, or a combination thereof. The artificial intelligence module 180 may be configured to extract and receive data from the data sink layer 170.

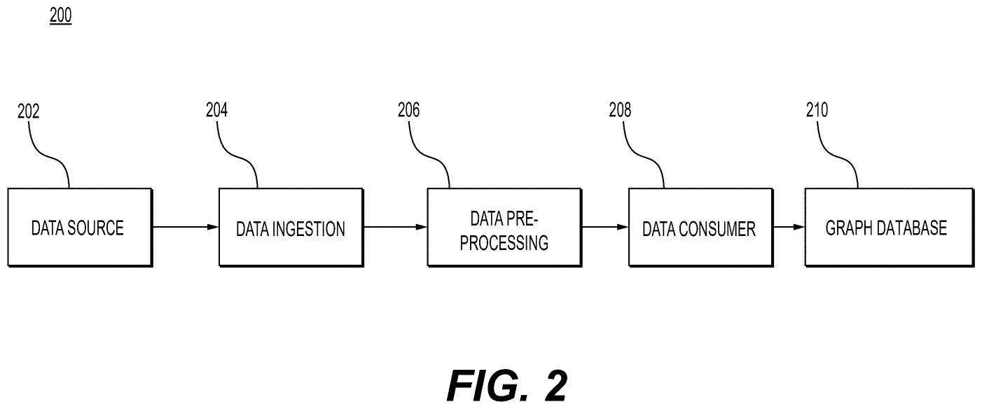

FIG. 2 depicts a system 200 for managing configuration items and time-based correlated events in a graph database, according to one or more embodiments.

The system 200 may first include a data source 202 (e.g., data source 101). The data source 202 may be configured to ingest various data related to an IT operation data. For example, the data source 202 may ingest data related to six data types: CI (configuration item), CI relationship, incidents, alerts, changes, and problems. Any of or all of the incidents, alerts, changes, and problems data may collectively be referred to as event data. The received data may include identifying information in addition to additional fields of data. The additional fields of data may vary depending on the type of data ingested. In an exemplary case, the data source 202 may be Servicenow.

The system 200 may include a data ingestion module 204 (e.g., the collection point 120 or the front gate processor 140) configured to extract data from the data source 202. The data ingestion module 204 may receive data in a raw unprocessed format. The data ingestion module 204 may be configured to write and assign specific data to a particular topic to be further processed. This determination may be based on the identification information and additional fields of data received. For example, received event topic may be assigned to separate topics than CI related data which may be assigned to a separate topic.

The system 200 may include a pre-processing module 206 (e.g., the processing platform 160) configured to read particularly assigned topics from the data ingestion module 204 as the topics are being written and assigned in the data ingestion module 204. Based upon the particular topic assigned, the pre-processing module 206 may process the data in particular ways. The pre-processing module 206 may further insert additional fields to be forwarded to a data consumer layer 208. For example, depending on the type of data received from the data source 202, the pre-processing module 206 may assign various data of additional fields to a respective topic. The pre-processing module 206 may be configured to process data in a stream or as batch data.

The system 200 may further include a data consumer layer 208 (e.g., performed by an additional front gate processor similar to front gate processor 140). The data consumer layer 208 may perform processing on the received data. The data consumer layer 208 may for example receive a topic associated with the data, along with additional fields of data and proceed with processing the data. For example, data consumer layer 208 may, for each message received by the pre-processing module 206, extract the key value/pairs and map the incoming data to nodes within the graph database 210. Alternatively, the data consumer layer 208 may create one or more new nodes if the current node doesn't exist, assigning labels to each piece of data depending on the data type. Determining whether a current node exists may involve performing a search of the graph database 210 described below to determine whether an identical identifier for a received piece of data exists as a node. The data may then be transferred to a graph, storage, and/or sink layer.

The system 200 may further include a graph database 210. The graph database 210 may be configured to consume and store the processed data. The graph database 210 may be a knowledge based graph database stored in a data sink layer 170. In an example, the graph database may be a Neo4j database. The graph database 210 may for example includes (1) CI nodes, (2) CI-Relationship nodes; (3) event nodes, (4) time nodes representing dates of time; and (5) edges connecting sets of two nodes. The graph database 210 may further be configured to receive commands to batch the created and/or updated nodes and insert the respective nodes and edges into the graph database 210.

Examining the nodes of the graph database 210, the CI nodes may include a primary key labeled as the “sys_ids” field, which may be the anchor for CI-to-CI relationships as well as CI to event node relationships. This field may determine either if a new node should be created or an existing node should be updated with the newest data found in the message (e.g., as determined by the data consumer layer 208). This field, along with other important fields such as CI name, asset class, active status, data center locations, etc., may be mapped as properties of the node. The system may assign at least (?) two labels to each CI: CI and the name of the CI's asset class. This may allow for further distinguish CI types, making the queries more efficient. The system may also read from a second topic which provides CI to CI relationship data. These relationships may be constructed in a parent to child hierarchy. The system may create relationships between each CI node, ‘HAS_PARENT’ and ‘HAS_CHILD’. This allows users of the system described herein to easily traverse the CI Hierarchy either upstream or downstream and extract key information which may be missing in the initial data such as the assigned Line of Business.

The CI relationship nodes may include a primary key (e.g., an identifier). The primary key of the CI Association node may be referred as the ci_association_id, and it may be constructed from the identifier (e.g., the sys_ids) of both CIs being associated. This may ensure that all CI association nodes are unique and can be queried efficiently when the system has an update to a property or relationship. Other properties of the node include “CI1” and “CI2.” The CI1 and CI2 may each represent an identifier (e.g., a sys_ids) of a particular configurable item, in particular they may represent the identifiers of the two configurable items being associated. The other properties of the node further include a confidence score, the confidence score assigning a confidence value for how related two CIs are. The other property may further rinclude updated_date which is the date for when the association rules have been updated. The sys_ids defined in the “CI1” and “CI2” properties may be utilized to query the appropriate CI nodes and construct a relationship labeled “HAS_CI_ASSOCIATION”. This relationship allows may allow the system to efficiently query additional CI information that is not available within the CI_Association node.

The graph database 210 may also include event nodes. The primary key of an event node may depend on the event type. For incidents, problems, and changes, the system may use ‘number’ as the unique key. For alerts the system may use ‘alertid’, which is a field we created during the pre-processing stage of the pipeline (e.g., the data pre-processing module 206). Similar to CI nodes, the system may use the primary key to determine if a node should be created or updated, and map the other fields as properties of the node. For each field that contains a timestamp, the system may extract the year, month, day, and time and create a relationship (e.g., create an edge) to the corresponding day node. The system may use the ‘cmdb_ci’ field ‘sys_id’ field for alert data) to create relationships from event node to CI and vice versa, creating relationships labels ‘[Event-Type]_HAS_CI’ and ‘CI_HAS_[Event_Type]’ respectively.

The graph database 210 may include time nodes also referred to as temporal relationship nodes. The addition of a time tree structure may allow the system to enhance data organization and analysis in the database and easily retrieved data based on time frames, historical comparisons, and temporal-based insights. The system may include time trees beginning with a year, branching down into months, then to days. For each of the event nodes that contain fields with a timestamp, the system may extract the year, month, date, and time and map it to the specified day node. The system may create and label the relationship based on the label of the property.

The system 200 may further be optimized. To ensure data integrity and prevent duplicates nodes of the same data, the system may implement constraints and indexes on the primary keys within the graph database 210. The system 200 may also implement indexes on all temporal properties of each node to allow for faster retrieval of data based on time ranges or specific time-related conditions. Additionally, the system 200 may leverage the tree traversal methods such as within the Awesome Procedures On Cypher (APOC) library to significantly reduce query times, especially with complex relationships among a large volume of nodes.

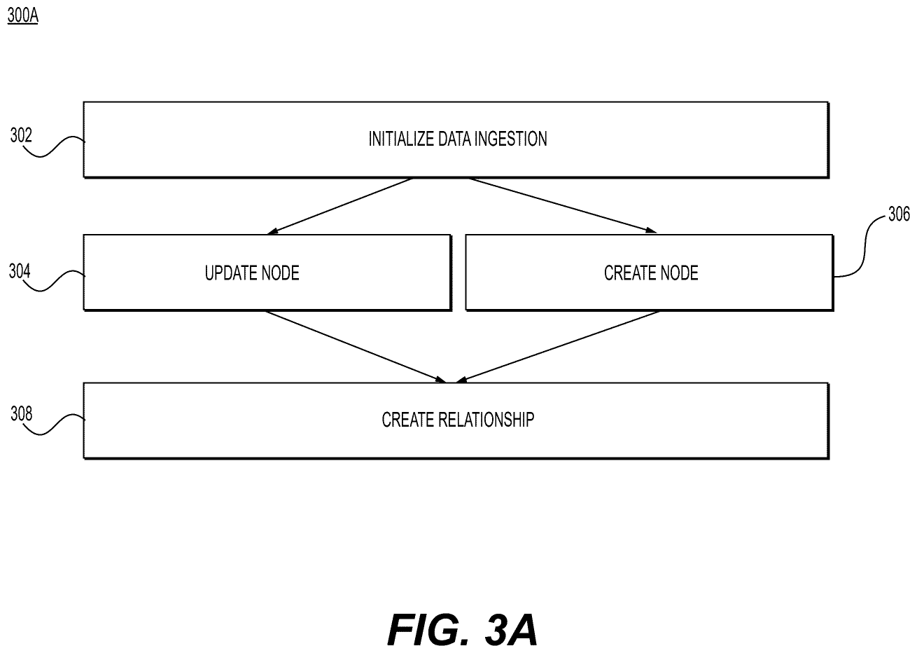

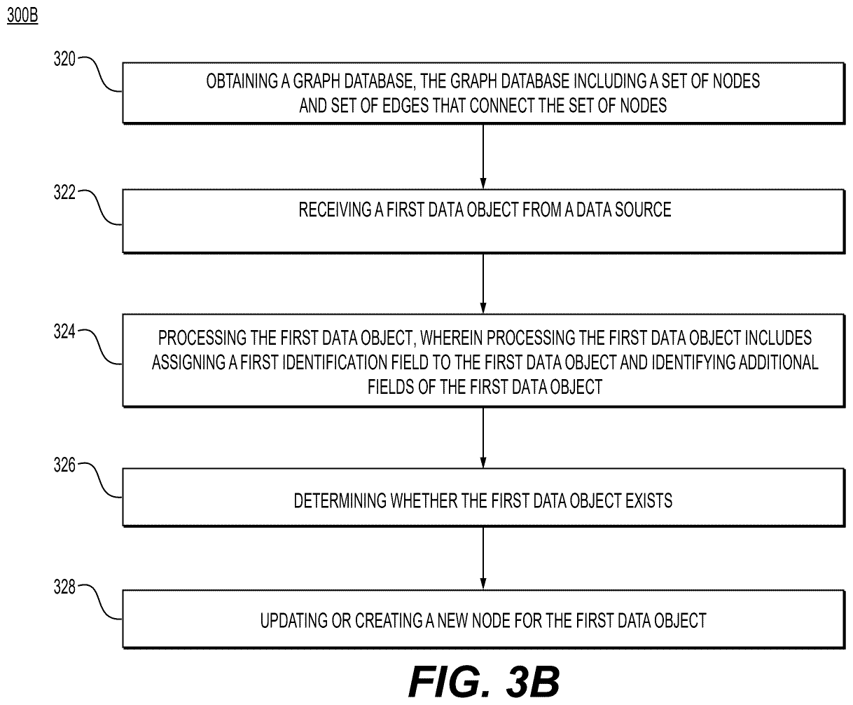

FIG. 3A depicts a flowchart of a method 300A for creating relationships in a graph database (e.g., the graph database 210), according to one or more embodiments. FIG. 3B depicts a flowchart of a method 300B for managing information technology event data in a graph database, according to one or more embodiments. The methods 300A and 300B described in FIG. 3A and FIG. 3B may be implemented by the data pipeline system 100 of FIG. 1 and/or by the system 200 of FIG. 2.

Method 300A may be applied both to update a graph database or to begin a new graph database. If method 300A is being applied to update a graph database, then prior to step 302 being performed (described below), the system may receive a graph database of IT operations data. The graph database may be a knowledge based graph with nodes and edges.

At step 302, the system (e.g., system 200) may initialize the data consumer layer 208 to read event/CI data topic and consume incoming messages. Based on the data type received, the data consumer layer may determine if a node exists in the graph database by using the primary key and node type.

At step 304, when the node was determined to exist at step 302, the system may update the values in the node with incoming data.

At step 306, when a node was not determined to exist at step 302, the system may proceed with creating a new node. In addition to creating a new node, the system may assign appropriate labels based on data type and mapping properties.

At step 308, the system may create one or more edges for either the new or updated node. This may involve connecting a CI to an identified parent or child (e.g., as read from the topic to determine the parent sys_id and child sys_id). This may also involve associating an event node with a CI and with a temporal node. Finally, this may involve, for a CI Relationship Node, creating an edge to each of the CI's referenced in the relationship. If a relationship (e.g., an edge) already exists in the graph database, the system may prevent duplicates (e.g., duplicative edges) from being created, and instead solely update attributes of the edge.

FIG. 3B depicts a flowchart of a method 300B for managing information technology event data in a graph database, according to one or more embodiments. Method 300B(?) may be applied each time a data object related to IT operation data is received by the system described herein. The method 300B may be applied on multiple data object simultaneously.

At step 320, the method may include obtaining a graph database, the graph database including a set of nodes and set of edges that connect nodes within the set of nodes. The graph database includes attributes for the set of nodes and attributes for the set of edges. The attributes may include identification fields that identify the type of data as well as identify each particular node. The attributes may further include additional fields that includes additional data related to each node or edge.

Further, the received graph database may include a set of temporal nodes. The temporal nodes may be in a tree format, with a year nodes, connected by an edge to twelve month nodes within that year, with the twelve month nodes each being connected to a respective node for the particular day of each month. The day nodes may be linked to one or more event or CI relationship nodes as described below. The tree format may allow for enhanced data organization and analysis of the database with retrieval of data based on time frames.

At 322, the method may include receiving a first data object. The first data object may include a first time stamp indicating an occurrence of the first data object. The first data object may be one of six types of information technology data, the data types including: being configuration item data, configuration item relationship data, incidents data, alert data, changes data, or problem data. The incident data, alert data, change data, and problem data may be collectively referred to as IT event data.

At step 324, the method may include processing the first data object, wherein processing the first data object includes assigning a first identification field to the first data object and identifying additional fields of the first data object. If the first data object is a configuration item, the first identification field may be a sys_id field. The additional fields identified may include a CI name (referred to as cmdb_ci), an asset class, an active status, data center location, an associated IP address, and/or a graph identification. The additional fields may also include a CI to CI relationship data, which identifies CI nodes as having a parent or child relationship (e.g., assigning “has_parent” to a parent and “has_child” and listing the related CI). If the first data object is a CI association, the first identification field may be labeled as the “ci_association_id, which may be constructed from the sys_ids of both CI's that will be associated. The additional fields identified may include properties “CI1” and “CI2” which are the two sys_ids being associated, a confidence level in an association (e.g., a value for how likely that two CIs are related), and the updated_date which is the data for which the association rules have been updated.

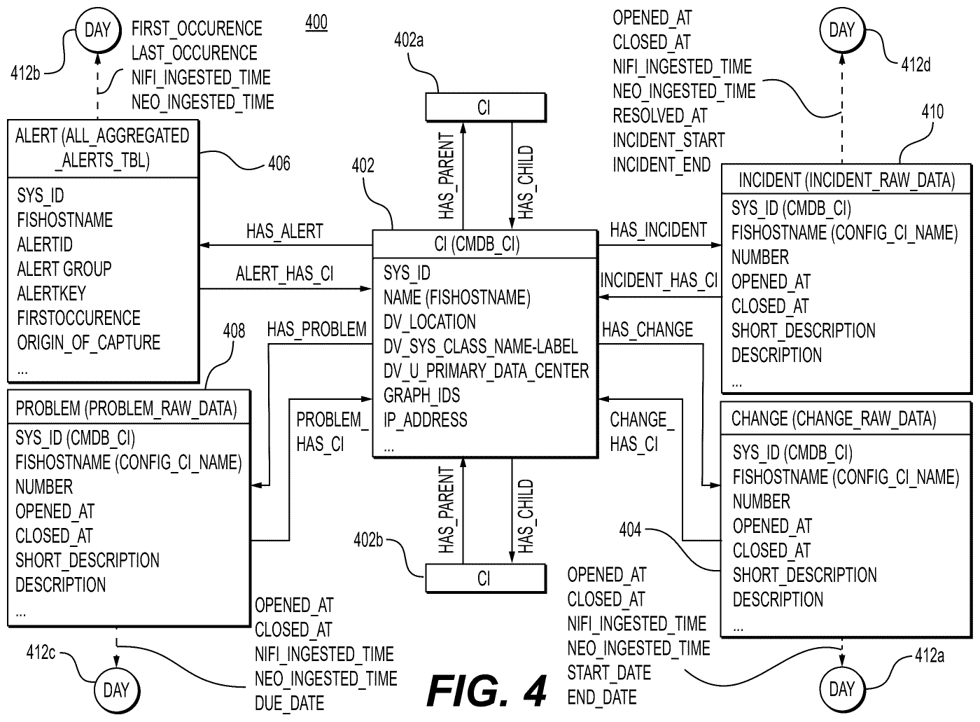

If the first data object is event data, the first identification field may be as follows. For incidents, problems, and changes the system may utilize “numbers” as a unique key to identify the event. For alert, the first identification field may use “alerted” which may be a field created during pre-processing of the data. The field data may include a timestamp that includes the year, month, and day of the event. This may be utilized to create an edge connection to a time node. The field data may further include a “cmbdb_ci” field or a “sys_ci” field to link the particular event data to a CI. This may be utilized to create an edge connection to a related CI node. For an alert, the additional field data may include a host name, an alerted, an alert group, an alert key, and first occurrence, and/or origin of capture. For a problem, an incident, and a change, the additional field data may include a host name, a problem number, an opened at time, a closed time, a short description, and/or a full description. The identifier and additional fields of a CI and the IT data may be displayed in FIG. 4 as described below.

Next, at step 326 the method may include determining whether the first data object is defined within the obtained graph database. This may be performed by applying search function for the first identification field determined at step 324. For example, the entire graph database may be searched for the particular first identification field. The system may for example apply an algorithm to traverse all possible edges within the received graph database to search for the first identification field.

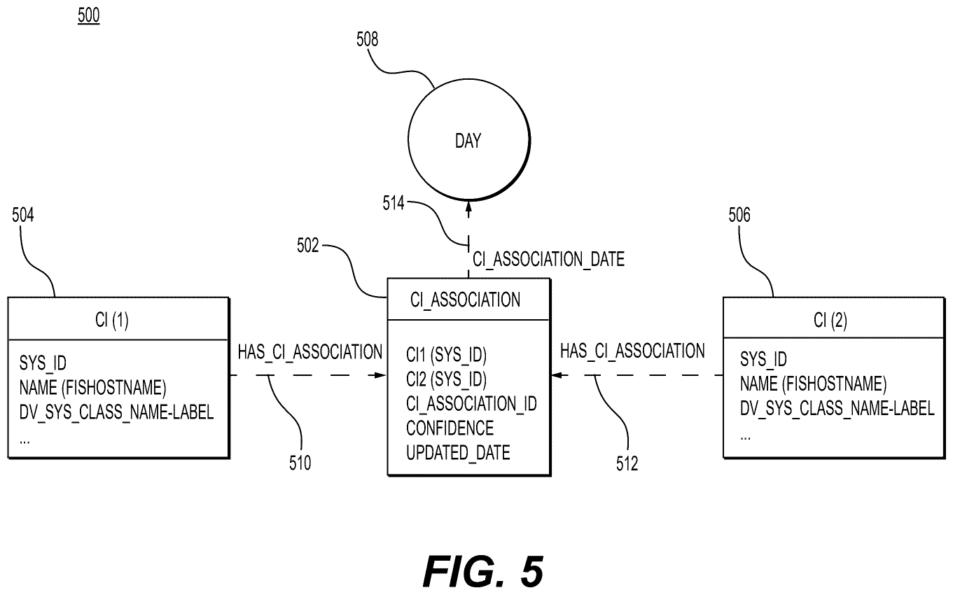

At step 328, if no node of the first data object was found, the method may include creating a first node for the first data object. This may further include creating one or more edges to link the first node to one or more additional nodes. For example, an event node may be linked to a temporal node and a CI node. A CI node may be linked to an event and one or more related CI. A CI relationship node may be linked to one or more CIs and a temporal node. Further, FIG. 4 depicts an exemplary diagram of a graph database 400 for event nodes and a configuration item node, according to one or more embodiments. The graph database 400 will be referenced for various aspects of step 328 to illustrate exemplary created/updated nodes and edges. Further, FIG. 5 depicts an exemplary node diagram 500 for configuration item association nodes, according to one or more embodiments.

For event data and CI relationship data, step 328 may include creating a first node in the graph database. This may include creating an edge connection to a first time node from the first node, the first time node identifying a time that the first data object occurred or was opened, the date being identified from the first time stamp of the first data object. This information may be located within additional field data. The first edge may further include attributes. For an alert, the attributes may include when an alert first occurred, last occurred, what time the alert was ingested by the system, and what time the alert was proceed. For a problem, incident, or change data, this may include what time the event was opened, closed, ingested, processed, the time the event began, and the time the event ended. For example, these exemplary connections for event data may be depicted in FIG. 4 by an alert node 406 linked to a temporal node 412b, by a problem node 408 linked to a temporal node 412c, by an incident node 410 linked to a temporal node 412d, and by a change node 404 linked to a temporal node 412a. The exemplary connections for CI relationship data may be depicted in FIG. 5 by a CI association node 502 linked by edge 514 to a temporal node 508. In general, when assigning attributes to an edge, the provided attributes may not be complete data, and only the known attributes may be assigned to a particular edge. In an exemplary temporal node case, if an incident occurred on March 22nd, at 8 pm in 2004, the node for Mar. 22, 2024 may be identified and an edge may by created linking the incident node to the date node. The edge attributes may include when the incident was opened and closed, what time the system ingested the incident, what time the system processed the incident, when the incident was recorded at beginning, and when the incident was recorded as ending.

At step 328, if the data type is a CI, the following may occur. The system may determine, based on the identification field data, that the data is a configuration item object. When the first node is created, the identification field may assigned as a first label to the first node. The additional fields identified at step 324 may be attributed to the first node as a second label. This may be shown in FIG. 4 by a CI node 402. Next, the additional fields may be searched to identify whether any CI to CI relationship data exists. If a CI to CI relationship field exists, the system may determine whether there is a parent CI node and/or a child CI node in the graph database. If a parent CI relationship exists, a first edge and a second edge may be created linking the first node to a node representing the parent CI. The first edge may include an attribute indicating “has_parent” and pointing to the parent CI. The second edge may point from the parent CI node to the first node and include an attribute indicating “has_child.” This may be depicted by the CI node 402 and by a CI node 402a as shown in FIG. 4. If a child CI relationship exists, a first edge and a second edge may be created linking the first node to a node representing the child CI. The first edge may include an attribute indicating “has_child” and pointing to the child CI node. The second edge may point from the child CI node to the first node and include an attribute indicating “has_parent.” This may be depicted by CI node 402 and CI node 402b as shown in FIG. 4.

At step 328, if the data type is event data, the following may occur. The system may determine, based on the identification field data, that the data type is event data. When the first node is created, the identification field may be assigned as a first label to the first node. The additional fields identified at step 324 may be attributed to the first node as a second label. This may be shown in FIG. 4 for an alert node 406, a problem node 408, an incident node 410, and for a change node 404. Next, based upon a “cmbdb_ci field” or a “sys_ci,” a linked CI may be determined for a particular event. This may be determined by a reference to the associated CI in the additional field data. A search may be done on the graph database to identify the particular CI node that is referenced in the additional field data. If the search finds the CI node in the graph, a first edge and a second edge may be created between the first node and the determined CI node. The first edge may point from the first node to the determined CI node and indicate that the event data has a CI in the first edge attribute. The second edge may point from the determined CI node to the first node and indicate that the CI has event data. By creating a two edges, each node may be linked to the corresponding node in later searches and/or analysis.

At step 328, if the data type is configuration relationship data, the following may occur. Examining FIG. 5, the node diagram 500 will be referenced for various aspects of step 328 to illustrate exemplary created/updated nodes and edges for a CI relationship. When a first node is created (e.g., CI association node 502), the identification field may be assigned as a first label to the first node. The additional fields at step 324 may be attributed to the first node as a second label (e.g., the CI1 (sys_id), CI2 (sys_id), ci_association_id, the confidence, and/or the updated_data). Next, the system may extract the CI1 and CI2 data fields and perform a search to determine the associated CI nodes (e.g., CI node 504 and CI node 506). Upon determining associated nodes for CI1 and CI2, a first edge (e.g., edge 510) may be created between the CI1 node and the association node. The edge may include an attribute listing that CI1 has an association and pointing towards association node (e.g., association node 502). Next, a second edge (e.g., edge 512) may be created between the CI2 node and the association node. The edge may include an attribute listing that CI2 has an association and is pointing towards association node (e.g., CI association node 502).

At 328, if at step 326 a first data object was determined to exist as an existing node, the method may include updating the existing node to include the updated additional fields of the data determined at step 324. Further, a search for any new associations within the additional fields may occur.

For example, for a CI node, a search may performed to identify whether any new CI to Ci relationship data exists in the additional fields. If any new CI to CI relationship data exists, a new set of edges may be created linking the CI's implementing the techniques discussed above.

For event data, a search may be performed for an additional field data indicating an occurrence time or opened at time may be conducted. If the time lists a new data then what is currently linked through an edge, a new edge may be created linking the event data to a new temporal node implementing the techniques discussed above. Further, a search for a new association based on the cmbdb_ci” field or a “sys_ci,” fields may be conducted. If a new association is determined, two new edges linking the event data node to the newly determined CI node may occur implementing the techniques discussed above.

For a CI relationship node, a search of the “updated_date” field may determine whether the association includes a new date. If the date is new, the system may link the CI association node to a new temporal node based on the new date implementing the techniques discussed above.

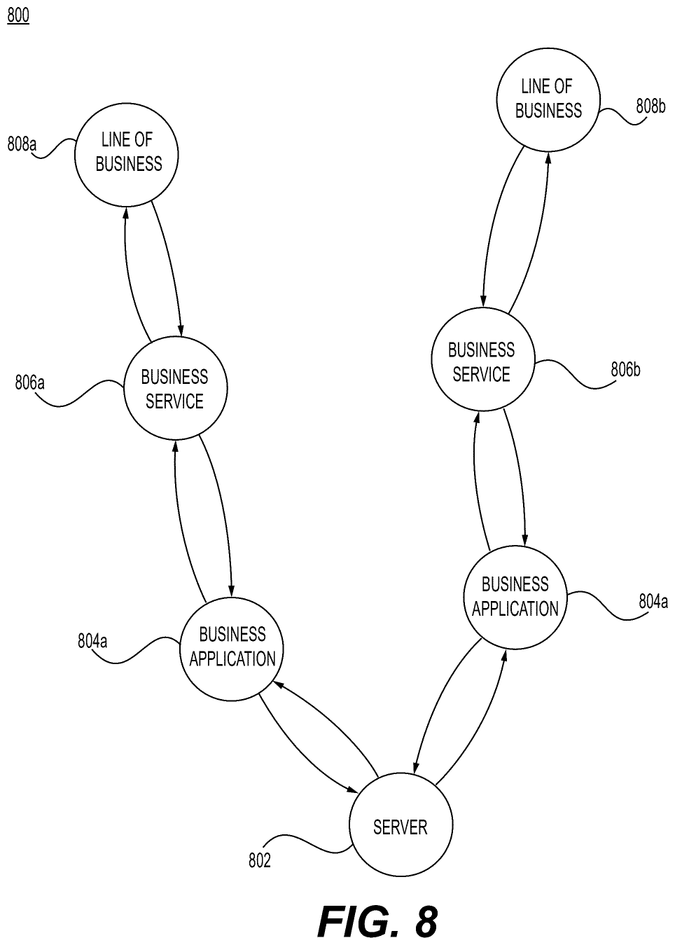

Upon the completion of step 328, the new nodes and association may be batch inserted into the graph database (e.g., graph database 210). This may then be saved to storage. The graph database may be accessed by one or more users to output search results and analysis related to IT data. Exemplary use cases of the updated graph may be shown in FIGS. 8, 9, 10, and 11 described below.

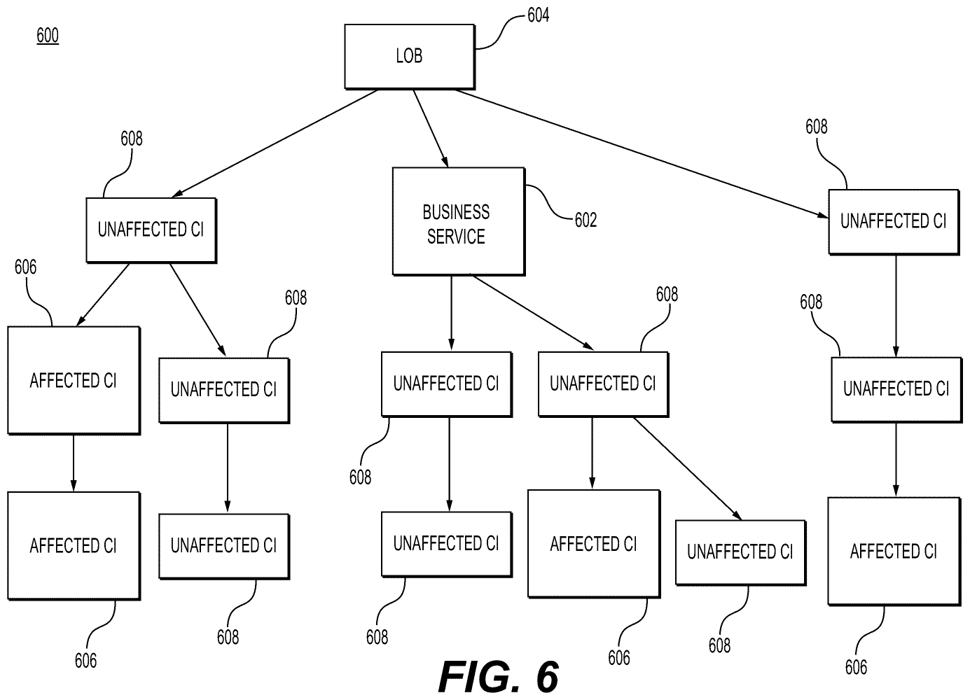

FIG. 6 depicts an exemplary hierarchical graph 600 of associated configuration item, according to one or more embodiments. FIG. 6 may assist in displaying why CI relationships may be important to graph within the graph database. The hierarchical graph 600 may include a LOB (Line of Business) 604 and edges, indicated by arrows, displaying relationships between respective CI's and the LOB 604. An IT event may occur to a business service 602 (e.g., a configurable item). As shown in hierarchical graph 600, a subset of affected CIs 606 may exist as well as a subset of unaffected CIs 608 may exist. As shown in the hierarchical graph 600, the business service 602 may not be related to or include relationships to particular affected CIs 606. While these affected CIs 606 might not have direct hierarchical connections to the affected CI, there may be a likelihood that these indirectly related CIs are experiencing issues stemming from the primary affected CI (e.g., business service 602). The system may consider various factors, including ongoing events affecting the CIs as well as historical events, aiming to identify potential similarities between these events and CIs. By implementing CI relationship associations, this may offers a systemic way of filtering and pinpointing essential CIs while revealing intricate relationships that might otherwise remain hidden. Storing these relationships in a graph database (e.g., as described in method 300) may be beneficial due to its ability to represent and efficiently navigate complex relationships between CIs.

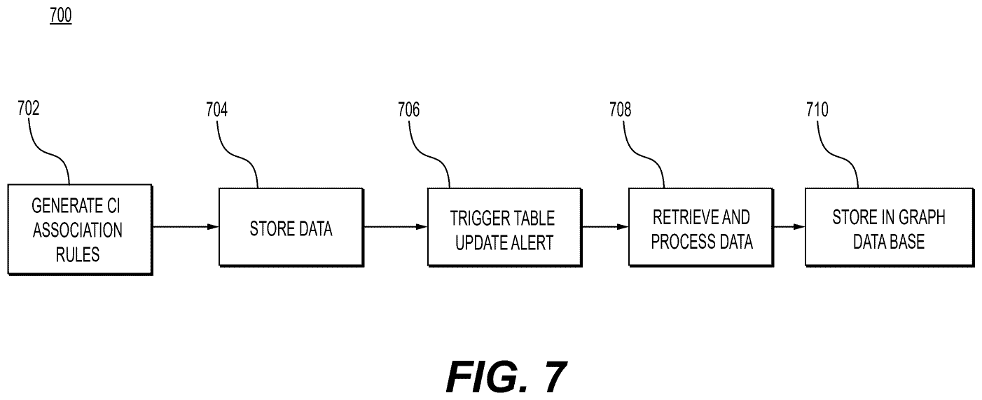

FIG. 7 depicts a flowchart 700 for processing and storing association rules in a graph database, according to one or more embodiments. FIG. 7 may be implemented by the data pipeline system 100 of FIG. 1.

At step 702, the method may include generating CI association rules. The CI association rules may for example be entered externally by a user or determined by applying algorithms to analyze a graph database of CIs. For example, CI associations may be created when particular events CIs have been impacted by events within a certain window of time. At step 704, the generated rules may be stored (e.g., into a storage system such as HIVE). At step 706, the system may issue a trigger table update alert (e.g., this may be performed by the front gate processor 140). Upon receiving the trigger table update, all associations rules from step 704 may be processed, and new association rules may be identified. For example, this may be done by having the front gate processor 140 read association rule topics and related incoming messages, wherein the incoming message may indicate that the table has previously been updated. Upon receiving this information, the process of reading and inserting the new association rules may begin. At step 708, the rules may be processed. When the association node exists, the nodes may be updated utilizing the techniques discussed in step 328. When the association nodes do not exist, the techniques of step 328 may be implemented to create a new node, assigning appropriate labels based on the data type and mapping properties. Further, the system may query appropriate CI and time nodes and create relationships between the association nodes as described at step 328. At step 710, the updated and/or new nodes may be batch inserted into the graph database.

FIG. 8 through FIG. 11 may depict various use cases of the graph database 210 described above. FIG. 8 depicts an exemplary segment 800 of a graph database's hierarchy, according to one or more embodiments. FIG. 8 further depicts the ability to retrieve a CI's line of business by traversing up a CI hierarchy in a graph database. The segment may include a first CI node 802 of a server. The CI node 802 may be connected by edges to two CI nodes 804a, 804b, where CI nodes 804a, 804b represent business applications. The edges may indicate the parent and child relationship between the respective CI's. The exemplary segment 800 may further include business services CI nodes 806a, 806, each of which are connected by edges to a respective LOB node 808a, 808b and CI nodes 804a, 804b. The exemplary segment 800 may show a small portion of nodes and edges for an exemplary graph database. Further, exemplary segment 800 may show all association and edges linking the first CI node 802 to one or more LOB nodes 808a, 808b.

The graph databases described herein may be configured to receive a query to retrieve a CI's (e.g., a CI's nodes) line of business by traversing up the CI hierarchy. In an example query, the system may receive a CI node's sys_id and use the APOC library to traverse all possible paths connected to the node up until a “Line of Business” node is found. In this example, the system described herein may be able to map two Line of Businesses for the exemplary node, which is information that the CI may not have had directly associated with it when first received. Further, relevant nodes may have been identified and all their properties evaluated. In an exemplary use case, the system described herein may obtain this information efficiently and quickly (e.g., in an example case the search may be performed within 0.008 seconds of a LOB search).

Exemplary code to retrieve the LOB may be shown below.

```
MATCH (n:CI {sys_id:’<CI_SYS_ID>’ })
  CALL apoc.path.spanningTree(n, {
    relationshipFilter: ″HAS_PARENT>″,
    uniqueness: ′NODE_GLOBAL′,
```

labelFilter: ′/Line of Business′,

```
    minLevel: 1,
    maxLevel: 20
  })
  YIELD path
  RETURN nodes(path)
```

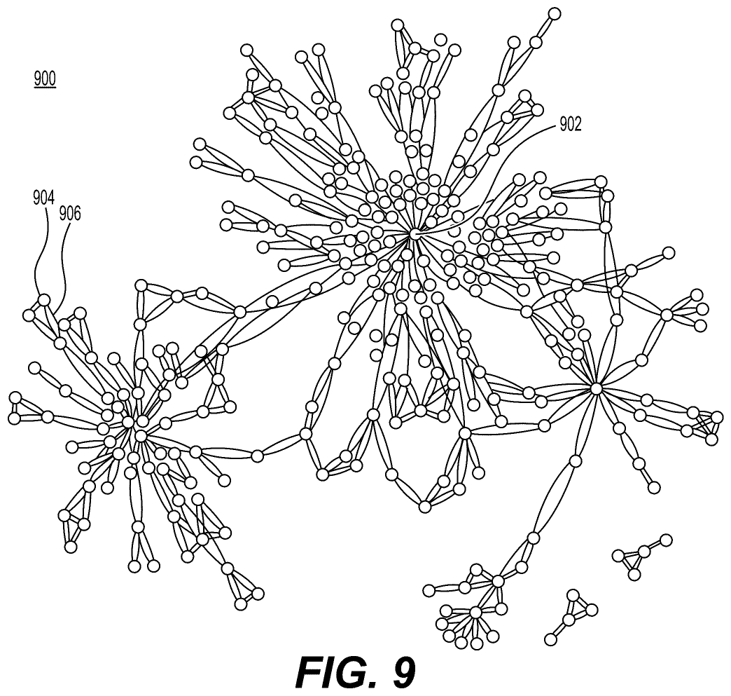

FIG. 9 depicts an exemplary graph 900 of a Line of Business (LOB) and associated nodes. as well as a retrieved entire set of associations for a particular LOB, according to one or more embodiments. The search may traverse down a requested set of levels (e.g., 20 levels in this example case). In this example, the system may receive a sys_id of a particular Line of Business node 902 and retrieve all nodes and relationships that fall within 20 levels below the given node. The system may be able to traverse down the hierarchy and display over 500 nodes and 1000 relationships efficiently and fast. For example, this example scenario may have obtained drawings within 0.208 seconds. The graph 900 may include all CI's including exemplary CI 904 and all edges including exemplary edge 906 for the particular LOB.

Exemplary code to retrieve an entire LOB tree may be shown below:

```
MATCH (n:‘Line of Business‘ {sys_id:’<CI_SYS_ID>’ })
  CALL apoc.path.spanningTree(n, {
    relationshipFilter: ″HAS_CHILD>″,
    uniqueness: ′NODE_GLOBAL′,
    minLevel: 1,
    maxLevel: 20
  })
  YIELD path
  RETURN path
```

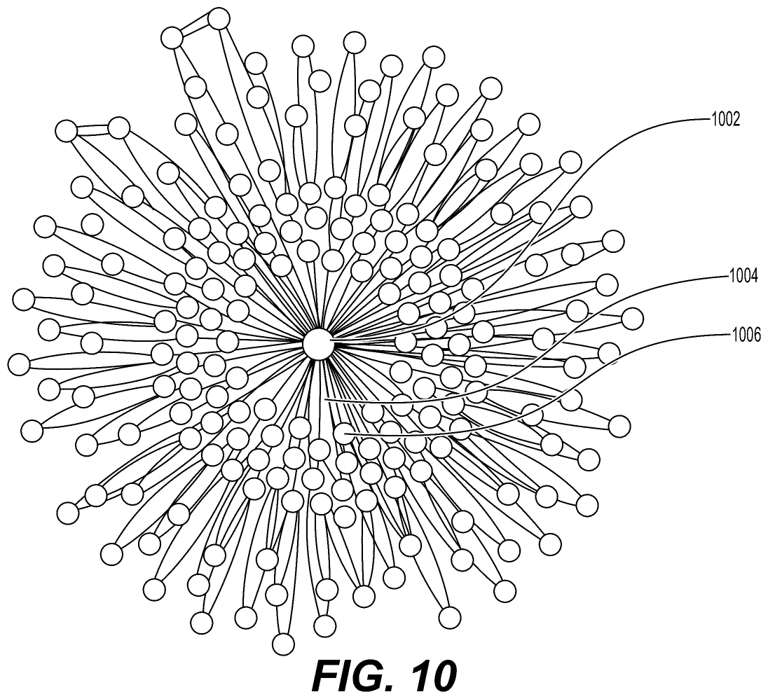

FIG. 10 depicts an exemplary graph 1000 of incidents that occurred during a day time interval, according to one or more embodiments. FIG. 10 describes how the system may retrieve all incidents that have occurred on a particular system from a graph database. In this example, the system may receive a query to retrieve all incidents that have occurred on a particular day. In this example, the system may receive a specific date that an individual may want to retrieve all incidents that have been opened on and return all incident information as well as the associated CI. Graph 1000 shows a temporal node 1002 associated with the input date, along with associations (e.g., edge 1004) to respective event data (e.g., event node 1006). The graph further includes all associated CI's associated with the determined event data. The system may traverse over 3000 incident nodes and their Cis efficiently and quickly. For example, this may be performed in 0.056 seconds.

Exemplary code to retrieve all incidents that have occurred on a particular day may be shown below:

```
with datetime(‘2023-03-19T00:00:00+00:00’) as start_date
  MATCH path =
  (d:Day)<-[:OPENED_AT]-(event:Incident)<-[ci_rel]-(ci:CI)
  WHERE d.day = start_date.day and d.month = start_date.month and
d.year = start_date.year
  return event.number, ci.sys_id
```

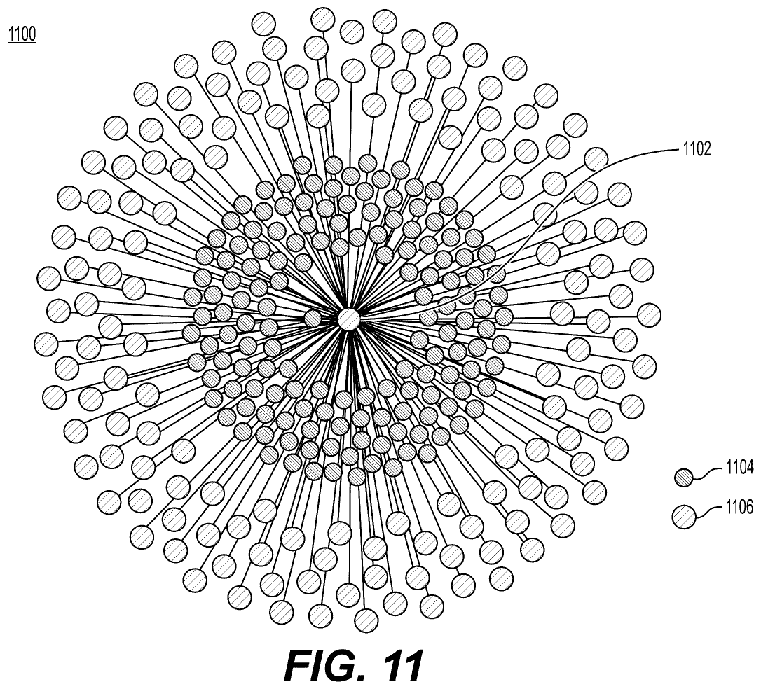

FIG. 11 depicts an exemplary graph 1100 of correlated configuration items, according to one or more embodiments. For example, graph 1100 may be output upon a search for a particular CI's (e.g., CI node 1102) correlated CIs. The graph 1100 depicts edges connecting the CI node (?) 1102 to association nodes, and additional edges connecting the respective association nodes to associated CIs. Exemplary code to show correlated CI's may be shown below. The output may be filtered to show correlated CI's with a requested confidence level. For example, in graph 1100 a confidence level of above 90% is requested.

MATCH (n:CI_Association) where
n.ci1 = ′<SYS_ID>’
or n.ci2 = ′<SYS_ID>’
and n.confidence >= .9
MATCH (ci:CI) where ci.sys_id = n.ci1 or ci.sys_id = n.ci2
return n,ci

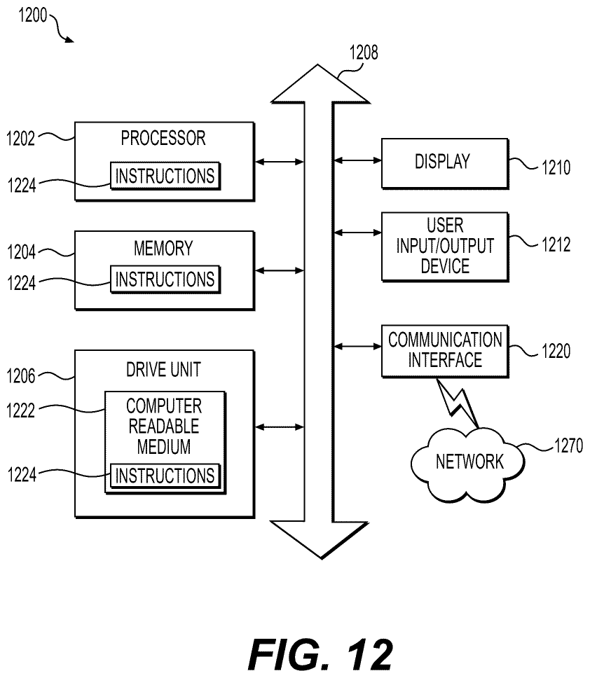

FIG. 12 illustrates a computer system 1200 for executing the techniques described herein, according to one or more embodiments of the present disclosure. As illustrated in FIG. 12, the computer system 1200 may include a processor 1202, e.g., a central processing unit (CPU), a graphics processing unit (GPU), or both. The processor 1202 may be a component in a variety of systems. For example, the processor 1202 may be part of a standard personal computer or a workstation. The processor 1202 may be one or more general processors, digital signal processors, application specific integrated circuits, field programmable gate arrays, servers, networks, digital circuits, analog circuits, combinations thereof, or other now known or later developed devices for analyzing and processing data. The processor 1202 may implement a software program, such as code generated manually (i.e., programmed).

The computer system 1200 may include a memory 1204 that can communicate via a bus 1208. The memory 1204 may be a main memory, a static memory, or a dynamic memory. The memory 1204 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 1204 includes a cache or random-access memory for the processor 1202. In alternative implementations, the memory 1204 is separate from the processor 1202, such as a cache memory of a processor, the system memory, or other memory. The memory 1204 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1204 is operable to store instructions executable by the processor 1202. The functions, acts or tasks illustrated in the figures or described herein may be performed by the programmed processor 1202 executing the instructions stored in the memory 1204. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel payment and the like.

As shown, the computer system 1200 may further include a display unit 1210, such as a liquid crystal display (LCD), an organic light emitting diode (OLED), a flat panel display, a solid-state display, a cathode ray tube (CRT), a projector, a printer or other now known or later developed display device for outputting determined information. The display 1210 may act as an interface for the user to see the functioning of the processor 1202, or specifically as an interface with the software stored in the memory 1204 or in the drive unit 1206.

Additionally or alternatively, the computer system 1200 may include an input/output device 1212 configured to allow a user to interact with any of the components of system 1200. The input/output device 1212 may be a number pad, a keyboard, or a cursor control device, such as a mouse, or a joystick, touch screen display, remote control, or any other device operative to interact with the computer system 1200.

The computer system 1200 may also or alternatively include a disk or optical drive unit 1206. The disk drive unit 1206 may include a computer-readable medium 1222 in which one or more sets of instructions 1224, e.g., software, can be embedded. Further, the instructions 1224 may embody one or more of the methods or logic as described herein. The instructions 1224 may reside completely or partially within the memory 1204 and/or within the processor 1202 during execution by the computer system 1200. The memory 1204 and the processor 1202 also may include computer-readable media as discussed above.

In some systems, a computer-readable medium 1222 includes instructions 1224 or receives and executes instructions 1224 responsive to a propagated signal so that a device connected to a network 1270 can communicate voice, video, audio, images, or any other data over the network 1270. Further, the instructions 1224 may be transmitted or received over the network 1270 via a communication port or interface 1220, and/or using a bus 1208. The communication port or interface 1220 may be a part of the processor 1202 or may be a separate component. The communication port 1220 may be created in software or may be a physical connection in hardware. The communication port 1220 may be configured to connect with a network 1270, external media, the display 1210, or any other components in system 1200, or combinations thereof. The connection with the network 1270 may be a physical connection, such as a wired Ethernet connection or may be established wirelessly as discussed below. Likewise, the additional connections with other components of the system 1200 may be physical connections or may be established wirelessly. The network 1270 may alternatively be directly connected to the bus 1208.

While the computer-readable medium 1222 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 1222 may be non-transitory, and may be tangible.

The computer-readable medium 1222 can include a solid-state memory such as a memory card or other package that houses one or more non-volatile read-only memories. The computer-readable medium 1222 can be a random-access memory or other volatile re-writable memory. Additionally or alternatively, the computer-readable medium 1222 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 1200 may be connected to one or more networks 1270. The network 1270 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 1270 may include wide area networks (WAN), such as the Internet, local area networks (LAN), campus area networks, metropolitan area networks, a direct connection such as through a Universal Serial Bus (USB) port, or any other networks that may allow for data communication. The network 1270 may be configured to couple one computing device to another computing device to enable communication of data between the devices. The network 1270 may generally be enabled to employ any form of machine-readable media for communicating information from one device to another. The network 1270 may include communication methods by which information may travel between computing devices. The network 1270 may be divided into sub-networks. The sub-networks may allow access to all of the other components connected thereto or the sub-networks may restrict access between the components. The network 1270 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel payment. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP, etc.) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosed embodiments are not limited to any particular implementation or programming technique and that the disclosed embodiments may be implemented using any appropriate techniques for implementing the functionality described herein. The disclosed embodiments are not limited to any particular programming language or operating system.

It should be appreciated that in the above description of exemplary embodiments, various features of the embodiments are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that a claimed embodiment requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment.

Furthermore, while some embodiments described herein include some but not other features included in other embodiments, combinations of features of different embodiments are meant to be within the scope of the present disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the function.

In the description provided herein, numerous specific details are set forth. However, it is understood that embodiments of the present disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the present disclosure, those skilled in the art will recognize that other and further modifications may be made thereto without departing from the spirit of the present disclosure, and it is intended to claim all such changes and modifications as falling within the scope of the present disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer-implemented method for managing information technology event data in a graph database, the method comprising:
obtaining a graph database, the graph database including a set of nodes and set of edges that connect the set of nodes;
receiving a first data object and a second data object from a data source, the first data object and second data object representing information technology data;
processing the first data object and the second data object, wherein processing the first data object includes assigning a first identification field to the first data object and identifying additional fields of the first data object, wherein processing the second data object includes assisting a second identification filed to the second data object and identifying additional fields of the second data object;
determining the first data object does not exist as a node in the graph database;
creating a first node for the first data object and assigning the first identification field to the first node;
creating a first edge connecting the first data object to a first related node from the set of nodes of the graph database;
determining the second data object does exist as a second node in the graph database; and
updating the second node to include the additional fields of the second data object.

2. The method of claim 1, wherein determining the first data object does not exist as a node in the graph database, further includes:
performing a search function to traverse all possible edges of the graph database to determine if the first identification field of the first data object exists as an identification field for any of the set of nodes in the graph database.

3. The method of claim 1, wherein creating a first node for the first data object further includes:
creating a third edge connection to a first time node, the first time node identifying a time that the first data object occurred, the time being identified from a first time stamp associated with the first data object;
wherein, wherein the first edge connection is attributed the additional fields of the first data object and indicates an association between the first node and additional data in the graph database.

4. The method of claim 1, wherein the graph database includes attributes for the set of nodes and attributes for the set of edges, wherein the attributes provide additional data related to define the set of nodes and the set of edges.

5. The method of claim 1, wherein each of the first data object and second data object comprises item data, configuration item relationship data, incidents data, alert data, changes data, or problem data.

6. The method of claim 1, further including:
determining the first data object is a configuration item object;
wherein the additional fields of the first data object include a name, asset class, and active status;
wherein creating the first node for the first data object includes:
assigning a first label of the first identification field; and
assigning a second label of the additional fields to the first data object;
wherein creating a first edge connecting the first data object to a first related node from the set of nodes of the graph database includes:
identifying a parent relationship and a child relationship;
identifying the first related node based upon parent relationship;
identifying a second related node based upon the child relationship; and
creating a second edge between the first node and second related node extracted from the child relationship.

7. The method of claim 1, further including:
determining the first data object is a configuration relationship object, wherein the configuration relationship object defines a relationship between a first configuration item and a second configuration item;
wherein the additional fields of the first data object include a first configuration item name identification field, a second configuration item name identification field, an association identification variable, a confidence of association, and an updated date that the association occurred;
wherein creating the first node for the first data object, includes:
assigning a first label of the first identification field; and
assigning a second label of the additional fields to the first data object;
wherein creating a first edge connecting the first data object to a first related node from the set of nodes of the graph database includes:
wherein the first related node is associated with the first configuration item name identification field; and
identifying a second related node associated with the second configuration item name identification field;
creating a second edge between the first node and the second related node; and
creating a third edge between the first node and a date node associated with the updated date from the additional fields of the first data object.

8. The method of claim 1, further including:
determining the first data object is an event object;
wherein creating the first node for the first data object, includes:
assigning a first label of the first identification field; and
assigning a second label of the additional fields to the first data object;
wherein the first related data object is identified based on the additional fields of the first data object.

9. The method of claim 1, wherein the graph database includes a time tree node structure, the time tree node structure including:
a year node;
twelve month nodes;
edges between the year node and each of the twelve month nodes;
nodes for each day of each of the twelve month nodes; and
edges between each day and the respective month nodes;
wherein, creating a second edge, linking the first node to a temporal node, wherein the temporal node represents a day that the first data object occurred or was opened on.

10. A system for managing information technology event data in a graph database, the system comprising:
a memory having processor-readable instructions stored therein; and
at least one processor configured to access the memory and execute the processor-readable instructions to perform operations including:
obtaining a graph database, the graph database including a set of nodes and set of edges that connect the set of nodes;
receiving a first data object and a second data object from a data source, the first data object and second data object representing information technology data;
processing the first data object and the second data object, wherein processing the first data object includes assigning a first identification field to the first data object and identifying additional fields of the first data object, wherein processing the second data object includes assisting a second identification filed to the second data object and identifying additional fields of the second data object;
determining the first data object does not exist as a node in the graph database;
creating a first node for the first data object and assigning the first identification field to the first node;
creating a first edge connecting the first data object to a first related node from the set of nodes of the graph database;
determining the second data object does exist as a second node in the graph database; and
updating the second node to include the additional fields of the second data object.

11. The system of claim 10, wherein determining the first data object does not exist as a node in the graph database, further includes:
performing a search function to traverse all possible edges of the graph database to determine if the first identification field of the first data object exists as an identification field for any of the set of nodes in the graph database.

12. The system of claim 10, wherein creating a first node for the first data object further includes:
creating a third edge connection to a first time node, the first time node identifying a time that the first data object occurred, the time being identified from a first time stamp associated with the first data object;
wherein, wherein the first edge connection is attributed the additional fields of the first data object and indicates an association between the first node and additional data in the graph database.

13. The system of claim 10, wherein the graph database includes attributes for the set of nodes and attributes for the set of edges, wherein the attributes provide additional data related to define the set of nodes and the set of edges.

14. The system of claim 10, wherein each of the first data object and second data object comprises item data, configuration item relationship data, incidents data, alert data, changes data, or problem data.

15. The system of claim 10, further including:
determining the first data object is a configuration item object;
wherein the additional fields of the first data object include a name, asset class, and active status;
wherein creating the first node for the first data object includes:
assigning a first label of the first identification field; and
assigning a second label of the additional fields to the first data object;
wherein creating a first edge connecting the first data object to a first related node from the set of nodes of the graph database includes:
identifying a parent relationship and a child relationship;
identifying the first related node based upon parent relationship;
identifying a second related node based upon the child relationship; and
creating a second edge between the first node and second related node extracted from the child relationship.

16. The system of claim 10, further including:
determining the first data object is a configuration relationship object, wherein the configuration relationship object defines a relationship between a first configuration item and a second configuration item;
wherein the additional fields of the first data object include a first configuration item name identification field, a second configuration item name identification field, an association identification variable, a confidence of association, and an updated date that the association occurred;
wherein creating the first node for the first data object, includes:
assigning a first label of the first identification field; and
assigning a second label of the additional fields to the first data object;
wherein creating a first edge connecting the first data object to a first related node from the set of nodes of the graph database includes:
wherein the first related node is associated with the first configuration item name identification field; and
identifying a second related node associated with the second configuration item name identification field;
creating a second edge between the first node and the second related node; and
creating a third edge between the first node and a date node associated with the updated date from the additional fields of the first data object.

17. The system of claim 10, further including:
determining the first data object is an event object;
wherein creating the first node for the first data object, includes:
assigning a first label of the first identification field; and
assigning a second label of the additional fields to the first data object;
wherein the first related data object is identified based on the additional fields of the first data object.

18. The system of claim 10, wherein the graph database includes a time tree node structure, the time tree node structure including:
a year node;
twelve month nodes;
edges between the year node and each of the twelve month nodes;
nodes for each day of each of the twelve month nodes; and
edges between each day and the respective month nodes;
wherein, creating a second edge, linking the first node to a temporal node, wherein the temporal node represents a day that the first data object occurred or was opened on.

19. A non-transitory computer readable medium storing processor-readable instructions which, when executed by at least one processor, cause the at least one processor to perform operations including:
obtaining a graph database, the graph database including a set of nodes and set of edges that connect the set of nodes;
receiving a first data object and a second data object from a data source, the first data object and second data object representing information technology data;
processing the first data object and the second data object, wherein processing the first data object includes assigning a first identification field to the first data object and identifying additional fields of the first data object, wherein processing the second data object includes assisting a second identification filed to the second data object and identifying additional fields of the second data object;
determining the first data object does not exist as a node in the graph database;
creating a first node for the first data object and assigning the first identification field to the first node;
creating a first edge connecting the first data object to a first related node from the set of nodes of the graph database;
determining the second data object does exist as a second node in the graph database; and
updating the second node to include the additional fields of the second data object.

20. The non-transitory computer readable medium of claim 19, wherein determining the first data object does not exist as a node in the graph database, further includes:
performing a search function to traverse all possible edges of the graph database to determine if the first identification field of the first data object exists as an identification field for any of the set of nodes in the graph database.
